(19) United States
(12) Patent Application Publication
(10) Pub. No.: US 2011/0111618 A1
(43) Pub. Date: May 12, 2011

(54) ELECTRICAL CONNECTOR

(75) Inventors: PING-SHENG SU, Tu-Cheng (TW); FAN-BO MENG, Kunshan (CN)

(73) Assignee: HON HAI PRECISION INDUSTRY CO., LTD., Tu-Cheng (TW)

(21) Appl. No.: 12/944,757

(22) Filed: Nov. 12, 2010

(30) Foreign Application Priority Data
Nov. 12, 2009 (CN) 200920314588.2

(51) Int. Cl. H01R 13/627

(52) U.S. Cl. 439/357

(57) ABSTRACT

An electrical connector (100) includes a base member (10), a cover member (20), a pull tab (80) and a pair of latch springs (70). The pull tab (80) has a pair of arms (82). Each arm has a latch releasing portion (83) at a free end of the arm. Each latch releasing portion (83) has an embossment (831) in front. Each spring (70) includes a main portion (71) formed a first indentation (74) therein, a pair of oblique portions (76) connecting the main portion and a connecting portion (77) connecting the two oblique portions from the up to down direction. The embossment (831) pushes the connecting portion (77) to drive the main portion (71) outwardly when the pull tab (80) is pulled backwardly.

### BACKGROUND OF THE INVENTION

1. Field of the Invention

The present invention generally relates to an electrical connector, and more particularly to an electrical connector having a locking mechanism.

2. Description of Prior Art

With the development of communication and computer technology, high density electrical connectors with conductive elements in a matrix arrangement are desired to construct a large number of signal transmitting paths between two electronic devices. Such high density electrical connectors are widely used in internal connecting systems of servers, routers and the like devices requiring high speed data processing and communication.

An electrical connector comprises a base and a cover assembled together. A pull tab is assembled to the base and has a pair of arms. Each arm has a latch releasing portion at a free end thereof. Each latch releasing portion defines a protrusion protruding outwardly from an outer face thereof. A pair of latch springs are mounted on the base and cooperate with the latch releasing portions. An elongated cutout is defined in a body portion of the latch spring. The latch releasing portions connects with the latch springs and the protrusions slide in the elongated cutout. When the latch releasing portions moves, the latch springs also moves in a predetermined manner. However, when the elongated cutout has burrs on both sides, the protrusion will be immovable in the elongated cutout. Therefore, the protrusion can not rebound from the elongated cutout.

Hence, an improved electrical connector is desired to overcome the above problems.

### BRIEF SUMMARY OF THE INVENTION

According to one aspect of the present invention, an electrical connector comprises: a base member, a cover member assembled with the base member to define a space therebetween, a pull tab having a pair of arms and a pair of latch springs including a main portion; each arm having a latch releasing portion at a free end of the arm, each latch releasing portion having an embossment in front; each latch spring including a first indentation and a pair of oblique portions connecting the main portion and extending backwardly from the main portion; the latch spring further including a connecting portion connecting the two oblique portions from the up to down direction, the embossment pushing the connecting portion to drive the main portion outwardly when the pull tab is pulled backwardly.

According to another aspect of the present invention, an electrical connector, comprising: a base member, a cover member assembled with the base member to define a space therebetween, a pull tab having a pair of latch releasing portions and a pair of latch springs including a main portion and a rear portion; each latch releasing portion having an embossment which is protruding outwardly from an outer face of the latch releasing portion; the main portion including a first indentation, the rear portion including a second indentation; the latch spring further including a connecting portion which is between the first indentation and the second indentation, the embossment pushing the connecting portion to drive the main portion outwardly when the pull tab is pulled backwardly.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

FIG. 1 is an exploded, perspective view of an electrical connector;

FIG. 2 is similar to FIG. 1, but viewed from another aspect;

FIG. 3 is an enlarged perspective view of a latch spring and a pull tab of the electrical connector shown in FIG. 1;

FIG. 4 is a partly assembled, perspective view of the electrical connector shown in FIG. 1;

FIG. 5 is an assembled, perspective view of an electrical connector shown in FIG. 1.

### DETAILED DESCRIPTION OF THE INVENTION

Reference will now be made to the drawing figures to describe the present invention in detail.

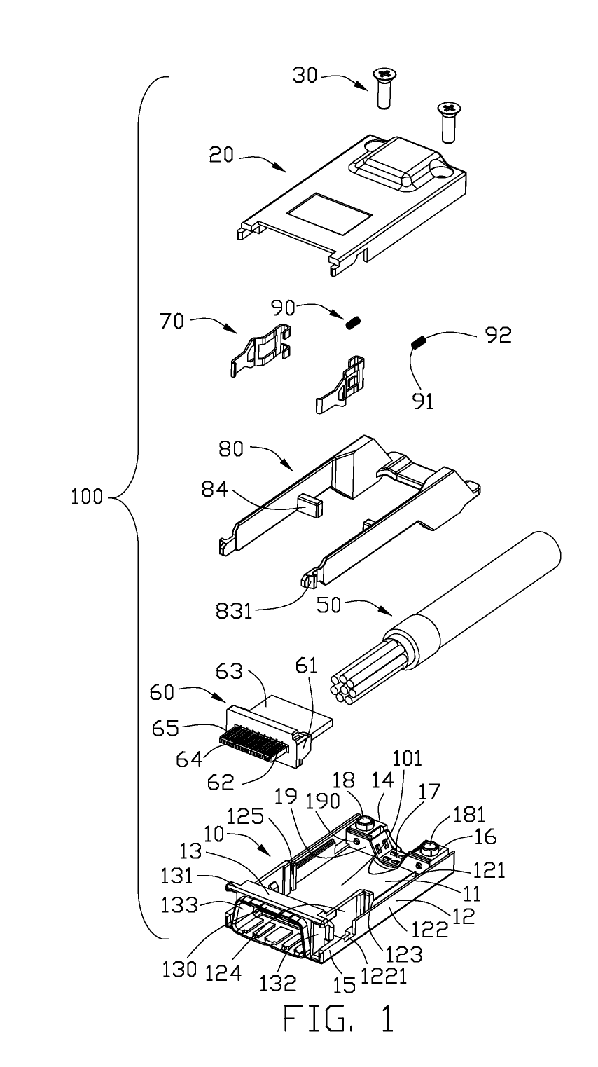

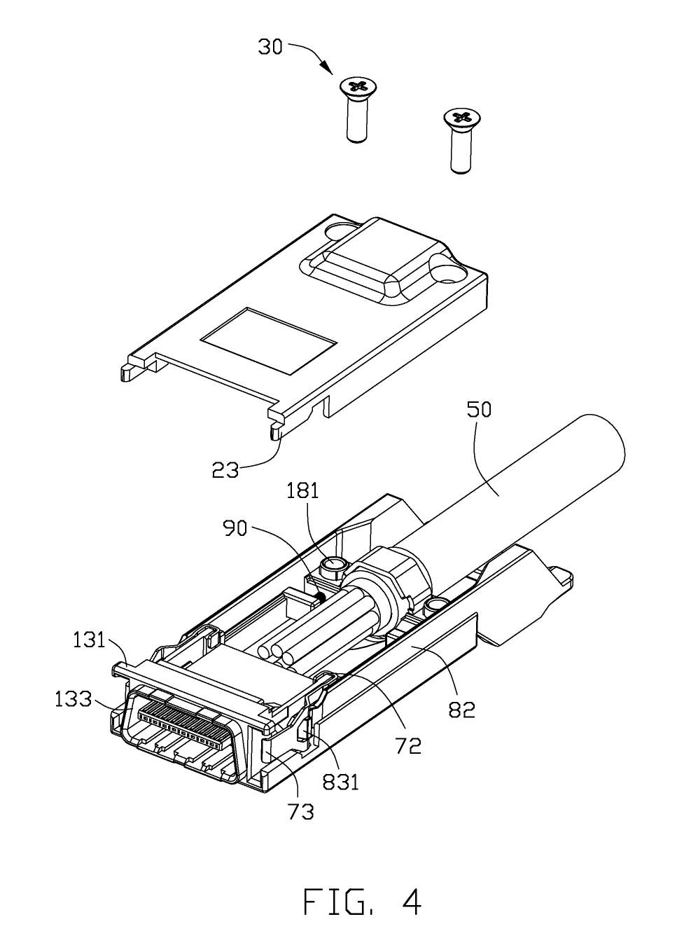

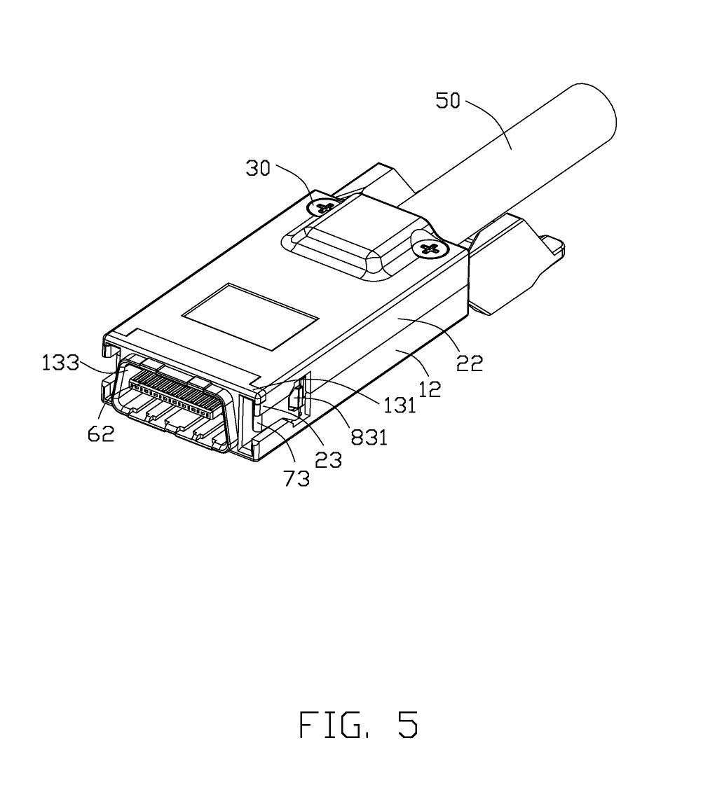

Referring to FIGS. 1-5, an electrical connector 100 of the present invention comprises a base member 10, a cover member 20 assembled on the base member 10, a pair of screws 30 fasten the cover member 20 to the base member 10, a terminal holder 60 received in a space defined between the base member 10 and the cover member 20, a pull tab 80 and a pair of latch springs 70 capable of being actuated by the pull tab 80 to separate the electrical connector 100 from a complementary connector.

As best shown in FIG. 1, both the base member 10 and the cover member 20 are formed by die casting metallic material. The base member 10 has a first receiving space 101 for receiving the terminal holder 60 defined by a base plate 11 and a pair of first sidewalls 12 which upwardly extend from opposite lateral sides of the base plate 11. Each first sidewall 12 defines a first elongated channel 121 from a rear end 14 toward a front end 15 and extending through a top engaging face 16 of the base member 10. The first elongated channel 121 separates each first sidewall 12 into a first outer sidewall 122 and a first inner sidewall 123. Each first inner sidewall 123 comprises a shoulder portion 124 adjacent to the front end 15 at opposite lateral sides of the first elongated channel 121 and a first cutout 125 formed adjacent to the rear end 14. Each shoulder portion 124 is higher than the first outer sidewall 122 and the first inner sidewall 123. Each first outer sidewall 122 comprises a notch 1221 adjacent to the front end 15.

As best shown in FIG. 1, the base member 10 also forms a base frame 13, a mating frame 130 extending forwardly from the base frame 13 at the front end 15 and a mating opening 133. The mating frame 130 is integrally formed with the base frame 13. The base frame 13 is formed with a pair of engaging ears 131 extending laterally from opposite top sides thereof and a pair of engaging channels 132 in opposite outer sides thereof. At the rear end 14 of the base member 10, a substantially semicircular first opening 17 is provided for the extension of a cable 50. At the opposite sides of the first opening 17, a pair of first cylindrical bodies 18 are upwardly extending through the top engaging face 16. Each first cylindrical body 18 has a screw hole 181 located inside thereof. The base plate 11 includes an inner face 19 which is perpendicular to the top engaging face 16 at the rear end 14 and a pair of protrusions 190 extending forwardly from the inner face 19. The rear end 14 of the base member 10 and the base plate 11 form a joint. The inner face 19 is located at the joint. The protrusions 190 are located at two sides of the first opening 17 respectively.

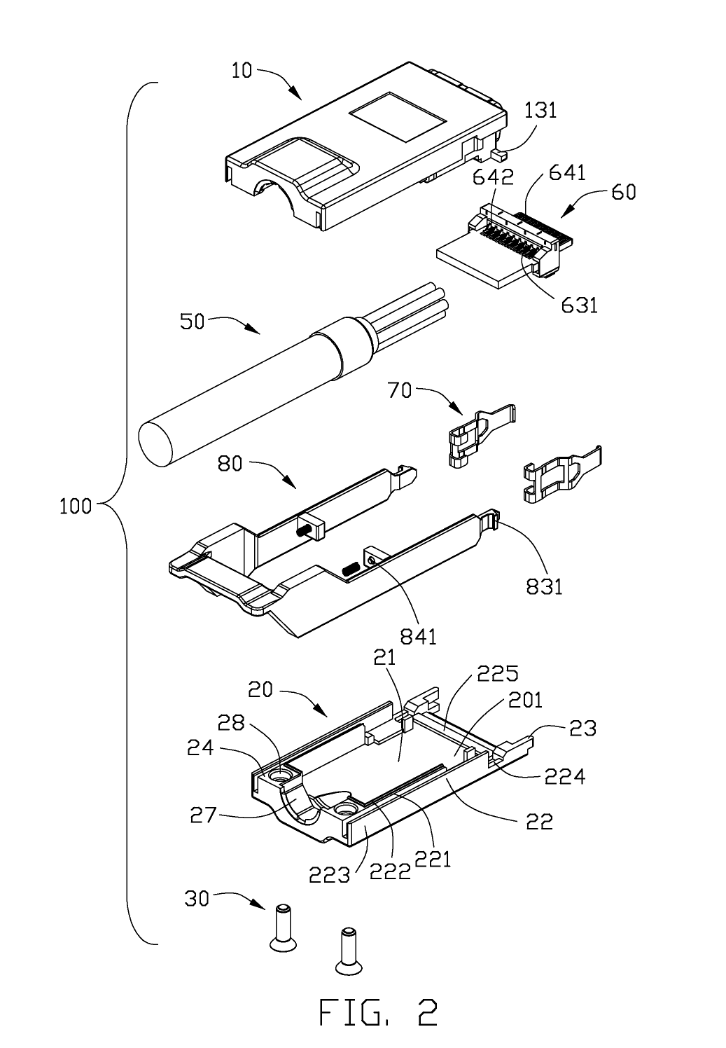

Particularly referring to FIG. 2, the cover member 20 defines a second receiving space 201 surrounded by a cover plate 21 and a pair of second sidewalls 22 extending downwardly from opposite lateral sides of the cover plate 21. Each second sidewall 22 defines a second elongated channel 221 corresponding to the first elongated channel 121 of the base plate 11. The second elongated channel 221 separates each second sidewall 22 into a second outer sidewall 222 and a second inner sidewall 223. A pair of projections 23 extend forwardly from opposite sides of a front end of the cover plate 21. A pair of second cutouts 224 are defined in respective second sidewalls 22 corresponding to the notches 1221 of the first outer sidewalls 122. A rib 225 protrudes downwardly from a front end of the cover plate 21. A substantially semicircular second opening 27 is provided in a rear end of the cover member 20 which is in correspondence with the first opening 17 of the base member 10. A pair of through-holes 28 are provided on opposite sides of the second opening 27. Each through-hole 28 has a diameter substantially equal to an outer diameter of each screw hole 181.

With reference to FIG. 1, the terminal holder 60 of the electrical connector 100 is shown in detail. The terminal holder 60 is assembled between the base member 10 and the cover member 20 and comprises an insulative housing 61, a tongue 62 extending forwardly from the insulative housing 61 and a printed circuit board 63 assembled onto a rear side of the insulative housing 61. A plurality of conductive pads 631 are formed on a forward end of both sides of the printed circuit board 63. A plurality of conductive terminals 65 are received in the conductive pads 631. The conductive terminals 65 extend throughout the insulative housing 61 and conduct with the printed circuit board 63. The conductive terminals 65 include a plurality of contacting portions 651 disposed in the tongue 62 and a plurality of soldering portions 652 electrically soldered with the printed circuit board 63. The contacting portions 651 are formed at a front end of the insulative housing 61 for electrically connecting with a complementary connector (not shown).

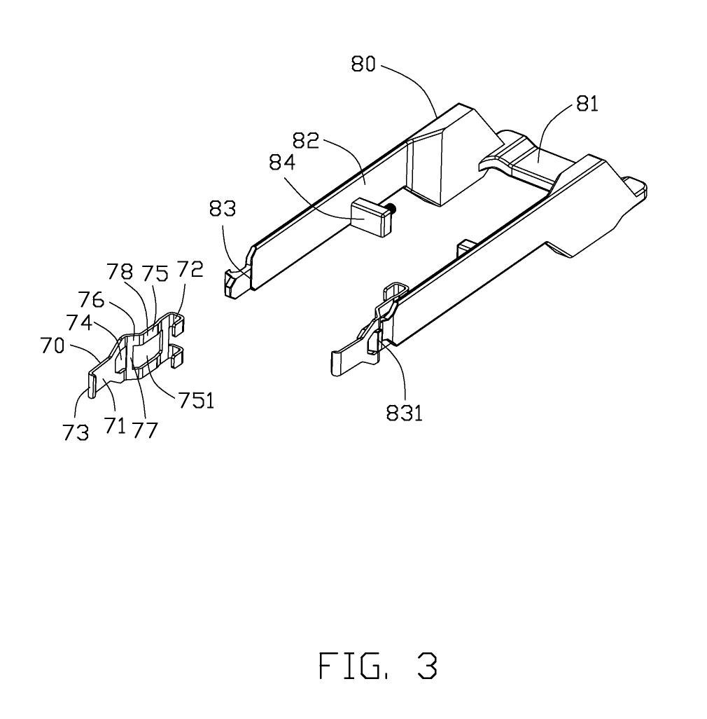

As best shown in FIG. 3, each latch spring 70 is typically made of metallic material. The latch spring 70 includes a main portion 71, an U-shaped claw 72 formed at back of the main portion 71 and a L-shaped claw 73 formed at front of the main portion 71. The main portion 71 forms a first indentation 74 at a rear end thereof. A rear portion 75 connects the main portion 71 and the U-shaped claw 72. The rear portion 75 includes a second indentation 751 which is throughout the rear portion 75, a pair of straight portions 78 located at opposite sides of the second indentation 751 from an up to down direction and a pair of oblique portions 76 located at opposite sides of the second indentation 751 from the up to down direction. The oblique portions 76 connect the main portion 71. The rear portion 75 includes a connecting portion 77 located between the first indentation 74 and the second indentation 751. The connecting portion 77 connects the two oblique portions 76 from the up to down direction.

As best shown in FIGS. 2-3, the pull tab 80 includes a transverse operable portion 81, a pair of parallel arms 82 extending forwardly from opposite sides of the operable portion 81, and a pair of latch releasing portions 83 formed at distal ends of the arms 82, respectively. Each latch releasing portion 83 has an embossment 831 protruding outwardly from an outer face thereof. A pair of blocks 84 extend from the inner surface of the two arms 82 respectively. The blocks 84 are behind the embossment 831. Each block 84 has a second cylindrical body 841 located in the middle of the block 84 and extended backwardly from the rear end thereof. Two springs 90 are assembled on the two second cylindrical bodies respectively.

Referring to FIGS. 1-5, in assembly, the terminal holder 60 is assembled to the base member 10 with the tongue 62 placed in the mating opening 133. The printed circuit board 63 locates in the first receiving space 101 of the base member 10. The two latch springs 70 are respectively assembled to the arms 82 of the pull tab 80 by extending the latch releasing portions 83 into the second indentation 751 from inner faces of the latch springs 70, therefore, the latch releasing portions 83 extend through the second indentation 751 from inner faces of the latch springs 70, the latch releasing portions 83 engage with the inner faces. The embossment 831 passes through the first indentation 74 from the left to right direction, the embossment 831 and the first indentation 74 lock with each other, therefore, the latch springs 70 and the pull tab 80 are fixed with each other steadily. The rear portions 75 of the latch springs 70 are arranged close to inner surface of the arms 82. Then, the latch springs 70 together with the pull tab 80 are assembled to the base member 10. The arms 82 of the pull tab 80 are placed into the first elongated channels 121 of the base member 10. The two releasing portions 83 are accommodated in the two notches 1221 respectively. The operable portion 81 is located outside the rear end 14 of the base member 10. The U-shaped claws 72 are received in the first cutouts 125 and fixed in the rear end of the shoulder portion 124, therefore, the latch springs 70 are assembled to the base member 10 stably. The L-shaped claws 73 are housed at opposite sides of the front end 15 of the base member 10 for latching with the complementary connector. Each spring 90 defines a first end 91 and a second end 92. The first ends 91 of the springs 90 are assembled on the second cylindrical bodies 841, the second ends of the springs 90 are assembled on the protrusions 190.

Referring to FIGS. 2-5, the cover member 20 is attached onto the base member 10 by placing the projections 23 below the pair of engaging ears 131. Then a rear portion of the cover member 20 is rotated downwardly about the pair of engaging ears 131 until the bottom face of the cover member 20 intimately abuts the top engaging face 16 of the base member 10. In this manner, the arms 82 are received in the second elongated channels 221. The first cylindrical bodies 18 are received in the through-holes 28. The first and second openings 17, 27 together form a cable exiting opening (not shown) for inserting the cable 50. Finally, the two screws 30 are screwed on the screw holes 181 to securely fasten the cover member 20 and the base member 10 together, whereby the electrical connector 100 in accordance with the present invention is obtained.

Referring to FIGS. 2-5, when the complementary connector is inserted into the electrical connector 100, the L-shaped claws 73 of the electrical connector 100 engage with the corresponding portion of the complementary connector. In a withdraw process of the complementary connector, the embossments 831 slide in the first indentation 74 by pulling the pull tab 80 along a front to rear direction. The embossments 831 push the oblique portion 76 outwardly when the embossments 831 abut against the connecting portions 77, the oblique portion 76 will rotate and the main portion will be pushed outwardly. Therefore, the L-shaped claws 73 of the electrical connector 100 break away from the complementary connector. Thus, the latch springs 70 break away from the complementary connector. When the electrical connector 100 is pulled out of the complementary connector, the latch springs 70 come back to the initial position by the springs 90. The springs 90 enhance the resilience of the latch springs 70.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a base member;
a cover member assembled with the base member to define a space therebetween;
a pull tab having a pair of arms, each arm having a latch releasing portion at a free end of the arm, each latch releasing portion having an embossment in front; and
a pair of latch springs including a main portion formed with a first indentation therein and a pair of oblique portions connecting the main portion and extending backwardly from the main portion;
wherein, the latch spring further includes a connecting portion connecting the two oblique portions from an up to down direction, the embossment pushes the connecting portion to drive the main portion outwardly when the pull tab is pulled backwardly.

2. The electrical connector as described in claim 1, wherein the latch spring further includes a second indentation, the first and second indentations locate in opposite sides of the connecting portion respectively.

3. The electrical connector as described in claim 2, wherein, the latch releasing portion extends through the second indentation from an inner face of the latch spring, the latch releasing portion engages with the inner face.

4. The electrical connector as described in claim 3, wherein the embossment passes through the first indentation from a left to right direction, the embossment and the first indentation lock with each other.

5. The electrical connector as described in claim 1, wherein the latch spring further includes an U-shaped claw extending backwardly from the main portion and a L-shaped claw extending forwardly from the main portion.

6. The electrical connector as described in claim 1, wherein the base member defines a first outer sidewall and a first inner sidewall, the inner sidewall comprises a shoulder portion and a first cutout, the U-shaped claw receives in the first cutout and fix in a rear end of the shoulder portion.

7. The electrical connector as described in claim 1, wherein the embossment is protruding outwardly from an outer face of the latch releasing portion.

8. The electrical connector as described in claim 1, wherein a block extends from the inner surface of the arm, a second cylindrical body locates in the middle of the block and extends backwardly from the block.

9. The electrical connector as described in claim 8, wherein the base member includes a base plate, a pair of first sidewalls which upwardly extend from opposite lateral sides of the base plate and a rear end, an inner face is perpendicular to a top engaging face of the base member at the rear end, a pair of protrusions extend forwardly from the inner face.

10. The electrical connector as described in claim 9, wherein a spring is assembled between the block and the inner face, the spring defines a first end and a second end, the first end is assembled on the second cylindrical body, the second end is assembled on the protrusions.

11. The electrical connector as described in claim 1, wherein the base member comprises a pair of engaging ears extending laterally from opposite top sides thereof, the cover member comprises a pair of projections extending forwardly from opposite lateral sides thereof, the projections are positioned below the corresponding engaging ears.

12. An electrical connector comprising:
a base member;
a cover member assembled with the base member to define a space therebetween;
a pull tab having a pair of latch releasing portion, each latch releasing portion having an embossment which is protruding outwardly from an outer face of the latch releasing portion; and
a pair of latch springs including a main portion formed with a first indentation therein and a rear portion formed a second indentation;
wherein, the latch spring further includes a connecting portion which is formed between the first indentation and the second indentation, the embossment pushes the connecting portion to drive the main portion outwardly when the pull tab is pulled backwardly.

13. The electrical connector as described in claim 12, wherein the rear portion includes a pair of straight portions located at opposite sides of the second indentation from the up to down direction and a pair of oblique portions located at opposite sides of the second indentation from the up to down direction, the oblique portions connect the main portion.

14. The electrical connector as described in claim 12, wherein the latch releasing portion extends through the second indentation from an inner face of the latch spring, the latch releasing portion engages with the inner face, the embossment passes through the first indentation from the left to right direction so as to lock with the first indentation.

15. An electrical connector comprising:
a casing;
an electrical connector disposed in a front portion of the casing;
at least one spring latch located upon an exterior of the casing and beside the connector;
a pull tab mounted to the casing and back and forth moveable relative to the casing in a front-to-back direction; and
the spring latch defines an offset structure with therein one indentation through which a front end section of the pull tab extends so as to have the pull tab interengaged with the spring latch in both lateral and front-to-back directions perpendicular to each other; wherein
the pull tab efficiently grasps a holding position of the said spring latch in front of said indentation to assure a backward movement of the pull tab results in an outward movement of a front tip of the spring latch without involvement of relative movement between the pull tab and the spring latch.

16. The electrical connector assembly as claimed in claim 15, wherein said spring latch further includes another indentation in front of said indentation, and the front end section of the pull tab defines a protrusion extends into said indentation.

17. The electrical connector assembly as claimed in claim 16, wherein said holding position is located between said two indentation in said front-to-back direction.
